(19) United States
(12) Patent Application Publication
(10) Pub. No.: US 2023/0314551 A1
(43) Pub. Date: Oct. 5, 2023

(54) POSITIONING DATABASE COMPUTING METHOD AND APPARATUS

(71) Applicant: ELECTRONIC AND TELECOMMUNICATIONS RESEARCH INSTITU, Daejeon (KR)

(72) Inventors: Myung In JI, Daejeon (KR); Young Su CHO, Daejeon (KR); Ju Il JEON, Daejeon (KR); Kyeong Soo HAN, Daejeon (KR)

(21) Appl. No.: 17/988,218

(22) Filed: Nov. 16, 2022

(30) Foreign Application Priority Data
Apr. 4, 2022 (KR) 10-2022-0041515

(51) Int. Cl. G01S 5/02; H04B 17/318

(52) U.S. Cl. CPC G01S 5/0284; H04B 17/318; G01S 5/0236

(57) ABSTRACT

Provided is a technology for operating a radio signal positioning database for object position tracking or search. Specifically, provided is a positioning database computing method and apparatus for generating and updating positioning data constituting a radio positioning database. The positioning database computing method includes comparing collected data received from a collection apparatus with positioning data in an existing positioning database to determine similarity therebetween, updating the existing positioning database using the collected data, upon determining that the data is similar as a result of comparison, and generating positioning data in the positioning database using the collected data, upon determining that the data is not similar as the result of comparison. Therefore, it is possible to gradually update the positioning DB even with partial collected data collected newly, so that it is possible to effectively manage the positioning DB reflecting the latest positioning environment.

### CROSS REFERENCE TO RELATED APPLICATION

The present application claims priority to Korean Patent Application No. 10-2022-0041515 filed Apr. 4, 2022, the entire contents of which is incorporated herein for all purposes by this reference.

### BACKGROUND OF THE INVENTION

### 1. Field of the Invention

The present disclosure relates to a technology for operating a radio signal positioning database for object position tracking or search. Specifically, the present disclosure relates to a positioning database computing method and apparatus for generating and updating positioning data constituting a radio positioning database.

### 2. Description of Related Art

Position estimation technologies using a wireless communication infrastructure are classified in various ways according to infrastructure types and service ranges. GNSS (Global Navigation Satellite System) refers to a system that determines a user's location using satellite signals on Earth's orbit, and GPS (Global Positioning System) in the US, GLONASS (Global Navigation Satellite System) in Russia, and Galileo in Europe similar thereto are currently in operation or are scheduled to be operated.

The GNSS provides high position accuracy and availability within 10 m in flat land or suburban areas where a direct line of sight of a satellite and receiver is secured. However, in dense urban areas that are non-line-of-sight areas, due to multi-path error, position error reaches 50 m, and reception sensitivity is lowered, especially in an indoor area, so that positioning is difficult because a signal cannot be acquired.

Among wireless communication infrastructures, cellular-based position estimation technology is a technology that determines the position of a user using location information and signal information of a mobile communication base station. Specifically, in the cellular-based position estimation technology, methods such as Cell-ID and base station signal pattern matching are used according to the number of base stations from which a terminal device may receive signals. This has an advantage of being able to determine the position indoors as well as outdoors due to the characteristics of the mobile communication infrastructure that covers most of downtowns and suburbs as a service range, but is excluded from a service requiring accuracy of several to tens of meters due to low position estimation accuracy.

Recently, position estimation technology using Wi-Fi has been mainly proposed indoors. In this method, a received signal strength indicator (RSSI) is collected by reference point for each Wi-Fi access point (AP) existing in a service area, a database is built, a terminal finds a pattern most similar to a signal strength received in a corresponding service area in the database and considers its reference point as a current position. Since the Wi-Fi-based position estimation technology has relatively high accuracy, it is applicable to an indoor navigation service, but it takes a lot of time and cost to collect a Wi-Fi signal, so there is a limit to building it in all buildings.

Regardless of availability of a satellite navigation system, it is necessary to store a received signal strength of a wireless communication resource in all areas where a terminal may be present in order to calculate the exact position of the terminal only with the wireless communication signal. In order to solve this problem, the present applicant proposed a technology of generating a positioning database (hereinafter referred to as “DB”) using partial data collected from the center of a road that a vehicle may enter, through Patent Application No. 10-2020-0033630 (Title of the Invention: Apparatus and method for generating a positioning database).

Therefore, through the invention of the patent described above, it is possible to build a positioning DB by predicting a wireless communication received signal strength even in an area where it is difficult for a vehicle to enter. However, as time goes by, if there is wireless communication infrastructure information that is newly added, modified or deleted for maintenance, a problem that the DB is aging occurred. As a simple method to solve the above problem, a method of rebuilding the positioning DB every time new data is collected may be considered, but, due to the properties of the data collected mainly by vehicles, there are many areas where data is not collected, and there is a disadvantage in that a processing time is very large when the positioning DB is built through summation with existing collected data.

### SUMMARY OF THE INVENTION

A technical object of the present disclosure is to provide a computing method and apparatus for more efficiently generating and updating a positioning DB as well as solving the problems of the prior art.

In addition, a technical object of the present disclosure is to provide a method and apparatus for effectively updating a pre-built positioning DB by using partially collected data in a technical field of estimating the position of a terminal using a wireless communication signal.

In addition, a technical object of the present disclosure is to provide a method and apparatus for tracking an emergency radio signal transmission position using a positioning DB, using a computing method and apparatus for generating and updating a positioning database.

The technical problems to be achieved in the present disclosure are not limited to the technical problems mentioned above, and other technical problems not mentioned will be clearly understood by those of ordinary skill in the art to which the present disclosure belongs from the description below.

A positioning database computing method according to an embodiment of the present disclosure comprises comparing positioning data (hereinafter referred to as ‘collected data’) received from a collection apparatus with positioning data in an existing positioning database to determine similarity therebetween, updating the existing positioning database using the collected data, upon determining that the data is similar as a result of comparison, and generating positioning data in the positioning database using the collected data, upon determining that the data is not similar as the result of comparison.

In addition, the positioning database computing method according to the embodiment of the present disclosure may further comprise collected data classifying step of classifying the collected data by base station or access point. In addition, it may further comprise clustering step of clustering the collected data classified through the collected data classifying step into small groups based on a collection position.

In addition, the clustering step comprises, even if it is collected data having the same delimiter, upon determining that it is an area required to be separated, classifying the area as an independent area.

In addition, in the positioning database computing method according to the embodiment of the present disclosure, the comparing comprises determining whether it is an infrastructure recorded in the existing positioning database, determining similarity between a signal strength of the collected data and a signal strength of an existing positioning database corresponding thereto, upon determining that it is an infrastructure recorded in the existing positioning data as a result of determination, and determining whether any one of a positioning database generation process or a positioning database update process is performed according to a result of determining similarity.

Here, the determining the similarity may comprise comparing a difference value between the signal strength of the collected data and the signal strength of the existing positioning database with a reference value, determining that the data is similar when the difference value is less than the reference value, and determining that the data is not similar when the difference value is greater than the reference value.

In addition, in the positioning database computing method according to the embodiment of the present disclosure, the updating the existing positioning database may comprise determining an update value by adding the collected data to the existing positioning database. The update value may be determined to be an average value of the collected data and corresponding positioning data in the existing positioning database. A weight may be given to the collected data in determining the update value.

In addition, the positioning database computing method according to the embodiment of the present disclosure may further comprise updating a live parameter value in a positioning database when the positioning database is generated or updated.

In this case, a live parameter of positioning data generated or updated in the positioning database may be set to a default value, the default value of the live parameter may be set to a positive integer value greater than 1. When the positioning database is generated or updated, a live parameter value of positioning data which is not generated or updated in the positioning database may be reduced by ‘1’, and positioning data whose the live parameter value is ‘0’ may be deleted from the positioning database.

In addition, a positioning database computing apparatus according to an embodiment of the present disclosure comprises a positioning database configured to store radio positioning data and a positioning database controller configured to control generation and update of the positioning database. In this case, the controller may compare received collected data with positioning data in an existing positioning database to determine similarity therebetween, update an existing positioning database using the collected data upon determining that the data is similar as a result of comparison and generate positioning data in the positioning database using the collected data upon determining that the data is not similar as the result of comparison.

In addition, in comparing the collected data with the positioning data in the existing positioning database to determine similarity therebetween, the controller may determine whether it is an infrastructure recorded in the existing positioning database, determine similarity between a signal strength of the collected data and a signal strength of an existing positioning database corresponding thereto, upon determining that it is an infrastructure recorded in the existing positioning data as a result of determination, and determine whether any one of a positioning database generation process or a positioning database update process is performed according to a result of determining similarity.

In addition, the controller may determine a update value by adding the collected data to the existing positioning database in updating the existing positioning database, and the update value may be determined to be an average value of the collected data and corresponding positioning data in the existing positioning database.

In addition, the controller may update a live parameter value in the positioning database when the positioning database is generated or updated, and a live parameter of positioning data generated or updated in the positioning database may be set to a default value which is a positive integer value greater than 1, and, when the positioning database is generated or updated, a live parameter value of positioning data which is not generated or updated in the positioning database may be reduced by ‘1’. Positioning data whose the live parameter value is ‘0’ may be deleted from the positioning database.

In addition, an emergency radio signal transmission position tracking apparatus using a positioning database according to an embodiment of the present disclosure comprises a positioning database configured to store radio positioning data, a positioning database controller configured to control generation and update of the positioning database, and a position tracking module configured to track a position where an emergency radio signal is generated using the positioning database, when the emergency radio signal is received. In addition, the positioning database controller of the emergency radio signal transmission position tracking apparatus may compare received collected positioning data with positioning data in an existing positioning database to determine similarity therebetween, update the existing positioning database using the collected data upon determining that the data is similar as a result of comparison, and generate positioning data in the positioning database using the collected data upon determining that the data is not similar as the result of comparison.

### BRIEF DESCRIPTION OF THE DRAWINGS

The above and other objects, features and other advantages of the present disclosure will be more clearly understood from the following detailed description taken in conjunction with the accompanying drawings, in which:

FIGS. 1 and 2 are diagrams for explaining positioning data collection for generating and updating a positioning database according to an embodiment of the present disclosure;

FIG. 3 is a diagram illustrating a basic flowchart of a computing method for generating and updating a positioning database according to an embodiment of the present disclosure;

FIG. 4 is a diagram illustrating a detailed flowchart of a computing method for generating and updating a positioning database according to an embodiment of the present disclosure;

FIG. 5 is a diagram for explaining a clustering step in a positioning database computing method according to an embodiment of the present disclosure;

FIG. 6 is a diagram illustrating a clustering process in a computing method for generating a positioning database according to an embodiment of the present disclosure;

FIG. 7 is a diagram illustrating an example of a collection area used in a computing method for generating and updating a positioning database according to an embodiment of the present disclosure;

FIG. 8 is a diagram illustrating an example of a positioning database structure in a computing method for generating and updating a positioning database according to an embodiment of the present disclosure;

FIGS. 9 and 10 are diagrams illustrating, for example, inconsistency (FIG. 9) and variability (FIG. 10) of collected data to illustrate the need for a computing method for generating and updating a positioning database according to an embodiment of the present disclosure;

FIG. 11 is a diagram illustrating a configuration of a computing apparatus for generating and updating a positioning database according to an embodiment of the present disclosure;

FIG. 12 is a diagram illustrating a configuration of a computing apparatus for generating and updating a positioning database according to another embodiment of the present disclosure; and

FIG. 13 is a diagram showing a configuration of an emergency radio signal transmission position tracking apparatus using a positioning database according to an embodiment of the present disclosure.

### DESCRIPTION OF THE PREFERRED EMBODIMENTS

Hereinafter, embodiments of the present disclosure will be described in detail with reference to the accompanying drawings so that those of ordinary skill in the art to which the present disclosure pertains can easily implement them. However, the present disclosure may be embodied in several different forms and is not limited to the embodiments described herein.

In describing the embodiments of the present disclosure, if it is determined that a detailed description of a well-known configuration or function may obscure the subject matter of the present disclosure, a detailed description thereof will be omitted. In addition, in the drawings, parts not related to the description of the present disclosure will be omitted, and similar portions are denoted by similar reference numerals.

In the present disclosure, when a component is “connected”, “coupled” or “linked” to another component, it may include not only a direct connection relationship but also an indirect connection relationship in which another component is present therebetween. In addition, when a component is said to “include” or “have” another component, it means that another component is not excluded and may be further included unless otherwise stated.

In the present disclosure, the terms such as first, second, etc. are used only for the purpose of distinguishing one component from other components, and, unless otherwise specified, the order or importance between the components is not limited. Accordingly, within the scope of the present disclosure, a first component in one embodiment may be referred to as a second component in another embodiment, and similarly, a second component in one embodiment is to referred to as a first component in another embodiment.

In the present disclosure, the components are distinguished from each other in order to clearly describe the characteristics of each component, and it does not necessarily mean that the components are separated. That is, a plurality of components may be integrated to form one hardware or software unit, or one component may be distributed to form a plurality of hardware or software units. Accordingly, even if not specifically mentioned, such integrated or distributed embodiments are also included in the scope of the present disclosure.

In the present disclosure, components described in various embodiments do not necessarily mean essential components, and some may be optional components. Accordingly, an embodiment composed of a subset of components described in one embodiment is also included in the scope of the present disclosure. In addition, embodiments including other components in addition to components described in various embodiments are also included in the scope of the present disclosure.

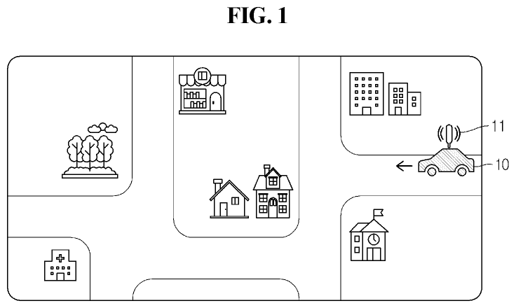

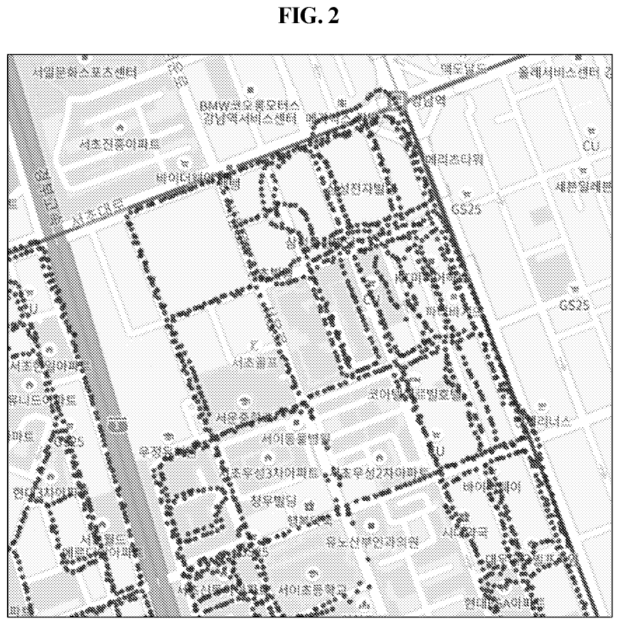

FIGS. 1 and 2 are diagrams for explaining positioning data collection for generating and updating a positioning database according to an embodiment of the present disclosure.

Referring to FIG. 1, a collection apparatus 10 receives a wireless communication signal periodically or frequently while moving, and stores information on the received wireless communication signal in combination with position information of a collection point where the wireless communication signal is collected. For example, the collection apparatus 10 may include a scan device 11 capable of collecting a wireless communication signal. The scan device 11 may collect a wireless communication signal such as a wireless broadband signal such as a long term evolution (LTE) signal or a fifth generation (5G) signal, a wireless local area network (LAN) signal such as a Wi-Fi signal, a personal area network (PAN) signal such as a Bluetooth low energy (BLE) signal. In addition, the collection apparatus 10 may include a positioning apparatus capable of measuring the collection position at a point where the wireless communication signal is received, for example, a global positioning system (GPS) apparatus.

The collection apparatus 110 may be, for example, a moving means such as a vehicle. Alternatively, the collection apparatus 10 may be, for example, an unmanned aerial vehicle (UAV), an unmanned robot, or the like. Alternatively, a person may collect positioning data by walking or biking while can-Ong the collection apparatus 10. The present disclosure is not limited to a specific example of the collection apparatus 10, and positioning data collected through various methods may be used.

For example, the collection point may be obtained by the moving collection apparatus 10, as shown in FIG. 2. Accordingly, the collection apparatus 10 is able to collect information on the wireless communication signal and position information at each collection point.

A positioning DB computing apparatus according to an embodiment of the present disclosure receives, from the collection apparatus 10, information on the wireless communication signal collected by the collection apparatus 10 and positioning data corresponding to the collection position. As an example, the positioning DB computing apparatus according to an embodiment of the present disclosure may receive the positioning data from the collection apparatus 10, for example, through wireless communication or wired communication. Alternatively, the positioning DB computing apparatus may receive positioning data from the collection apparatus 10 through a physical storage medium. As another example, the positioning DB computing apparatus according to an embodiment of the present disclosure may include the collection apparatus 10.

The positioning DB computing apparatus according to an embodiment of the present disclosure generates positioning data of an area not collected by the collection apparatus 10 or updates an existing positioning DB based on positioning data received from a plurality of collection apparatuses 10.

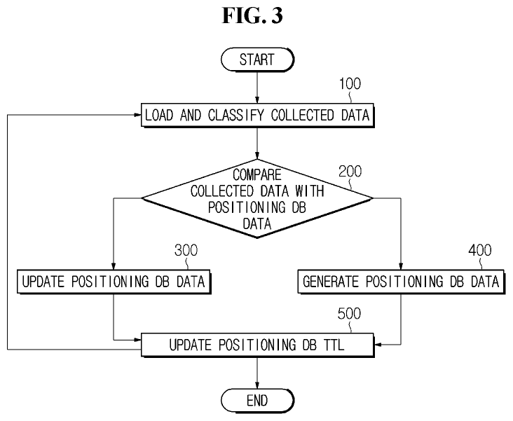

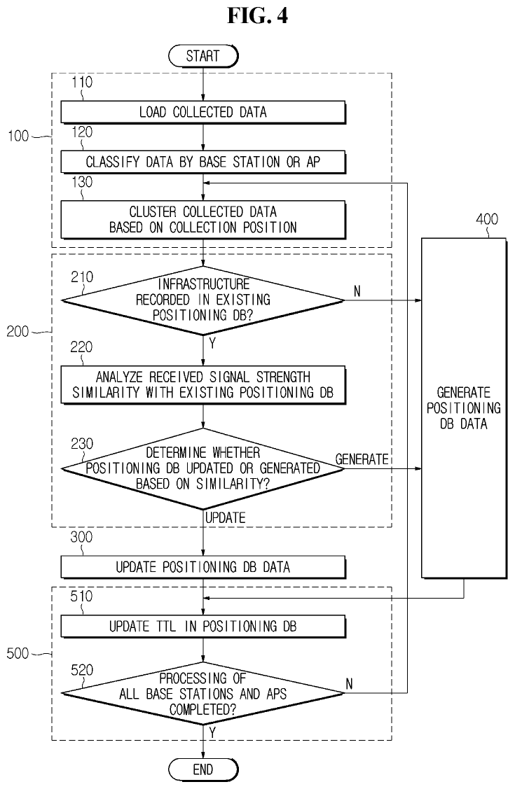

FIG. 3 is a diagram illustrating a basic flowchart of a computing method for generating and updating a positioning database according to an embodiment of the present disclosure, and FIG. 4 is a diagram illustrating a detailed flowchart of a computing method for generating and updating a positioning database according to an embodiment of the present disclosure.

Referring to FIG. 3, the computing method for generating and updating the positioning DB according to the embodiment of the present disclosure may include step 100 of loading and classifying collected data received from a collecting apparatus. In addition, the computing method for generating and updating the positioning DB according to the embodiment of the present disclosure may include step 200 of comparing the collected data with positioning data in an existing positioning DB to determine similarity. In addition, the computing method for generating and updating the positioning DB according to the embodiment of the present disclosure may include step 300 of updating the existing positioning DB using the collected data upon determining that they are similar as a result of comparison and step 400 of generating positioning data in the positioning DB using the collected data upon determining that they are not similar as the result of comparison. In addition, the computing method for generating and updating the positioning DB according to the embodiment of the present disclosure may further include step 500 of updating a specific parameter in the positioning DB (hereinafter referred to as a “live parameter” or “time-to-live (TTL) parameter”) when the positioning DB is generated or updated.

Each step of the computing method for generating and updating the positioning DB according to the embodiment of the present disclosure shown in FIG. 3 will be described in detail with reference to FIGS. 4 to 8.

First, the collected data classification step 100 of FIG. 3 may include loading the collected data received from the collecting apparatus (110) and classifying the loaded collected data for each base station or each access point (120).

Specifically, the positioning DB computing apparatus of the present disclosure loads the collected data (110). Data collection includes a method of collecting data by a person walking or standing at a certain point, a method of collecting data on a moving device such as a vehicle or a bicycle, a method of collecting data using a drone, a robot, etc., but the present disclosure is not limited thereto. Finally, the following information is included through the combination of logs.

*Collection point information (e.g., latitude and longitude coordinates)

*Information on the wireless communication signal acquired at the collection point
(In case of LTE) Base station unique identifier such as PCI, signal band or channel information, signal strength information (RSRP (Reference Signal Received Power), etc.)
(In case of Wi-Fi) AP (Access Point) unique identifier such as MAC address, signal strength information (RSSI (Received Signal Strength Indicator), etc.)
(In the case of BLE) Unique identifier of beacon such as MAC address, signal strength information (RSSI, etc.)

The loaded collected data is classified for each infrastructure (120). It is classified by base station or by channel (or by band) in the case of LTE, by MAC address, which is the unique identifier of the AP, in the case of Wi-Fi and by MAC address, which is the unique identifier of the beacon, in the case of BLE. Although L′I′E data is described as an example in this specification, the same method may be applied to wireless communication signals such as Wi-Fi and BLE.

In addition, step 100 of classifying the collected data of FIG. 3 may further include step 130 of clustering the collected data classified through the classifying step 120 into small groups based on the collection position. Here, in the clustering step 130, even if it is collected data having the same delimiter, upon determining that it is an area required to be separated through unsupervised learning, the corresponding area may be classified as an independent area.

In particular, in the case of LTE collected data or in the case of PCI, Wi-Fi, or BLE collected data, since the MAC address is not a unique value of each device, the same value may be received in different areas. Accordingly, if a delimiter (e.g., PCI or MAC address value) necessary for classifying infrastructures is received even though it is a sufficiently distant area, it needs to be clustered. The clustering step 130 may be performed using various techniques of unsupervised learning using the collection position, and a specific clustering method is omitted because it is outside the scope of the present disclosure.

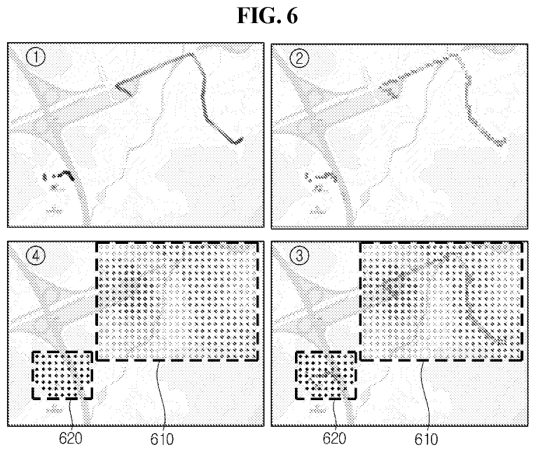

An example of actually applying the clustering step 130 will be described with reference to FIG. 6. FIG. 6 is a diagram illustrating an example of a collection position-based collected data clustering result. After loading the collected data having the same delimiter in FIG. 6 (e.g., the PCI of the LTE collected data) as shown in the upper left \textcircled{1}, in the case of the collected data formed at a sufficiently distant distance as in the upper right \textcircled{2}, it may be divided into two areas 610 and 620 using unsupervised learning clustering technique as shown in the lower right \textcircled{3}. As a result, the overall error can be improved by making the collected data correspond to the positioning DB of the areas 610 and 620 as shown in the lower left \textcircled{4}. If it is processed as one area without clustering, the overall error will increase by generating a positioning DB even in a non-collected area. However, the clustering step 130 may be flexibly applied rather than necessarily included in designing the positioning DB computing method and apparatus of the present disclosure.

Next, the step 200 of comparing with the existing positioning DB of FIG. 3 may include step 210 of determining whether it is an infrastructure recorded in the existing positioning DB, step 220 of determining similarity between the signal strength of the collected data and the signal strength of the corresponding existing positioning DB upon determining that it is the infrastructure recorded in the existing positioning DB as a result of determination, and step 230 of determining whether any one of a positioning DB generation process 400 or a positioning DB update process 400 is performed according to the result of determining similarly.

The infrastructure determination step 210 means, when clustering of the collected data is completed, it is determined whether the corresponding collected data is for the infrastructure recorded in the pre-built positioning DB. Therefore, if it is a new infrastructure that has not been recorded, it is generated as a positioning DB through the positioning DB generation process 400 (in case of ‘N’ in step 210). On the other hand, if it is the infrastructure recorded in the pre-built positioning DB (in the case of in step 210), it proceeds to step 220 of analyzing the received signal strength similarity with the existing positioning DB.

In addition, step 200 of determining the similarity may include comparing a difference value between the signal strength of the received collected data and the signal strength of the existing positioning DB with a reference value. That is, if the difference value is less than the reference value, it may be determined that they are similar, and if the difference value is greater than the reference value, it may be determined that they are not similar. Accordingly, upon determining that they are similar, the positioning DB update process 300 is performed. On the other hand, upon determining that they are not similar, the positioning DB generation process 400 is performed.

Specifically, if there is no change in the wireless communication infrastructure setting value or environments such as surrounding buildings, the received signal strength is similar to that of the existing positioning DB, so that the similarity with the existing positioning DB is high. For example, in the case of an infrastructure showing a similarity greater than or equal to a preset similarity reference value as the similarity determination result 230 (in the case of in step 230), a positioning DB update process 300 for adding a new collected value to the existing positioning DB is applied. On the other hand, if there is a change in the wireless communication infrastructure setting value or the surrounding environment, the received signal strength pattern may be different from that of the existing positioning DB. In other words, in the case of an infrastructure showing a similarity equal to or less than the preset similarity reference value, the positioning DB may be regenerated through the positioning DB generation process 400.

Next, the positioning DB update process 300 of FIG. 3 means determining an update value by adding the collected data to the existing positioning DB. Here, it is possible to determine the update value as a representative value (e.g., an average value) of the collected data and the corresponding positioning data in the existing positioning DB. In addition, in determining the update value, a method of giving a weight to the collected data may be applied. Since the collected data means more recent data, it may be given a higher weight than the existing positioning data. Alternatively, in consideration of the range of the existing positioning data, the weight of the collected data may be changed. For example, a higher weight may be given to collected data close to an average value of the existing positioning data range.

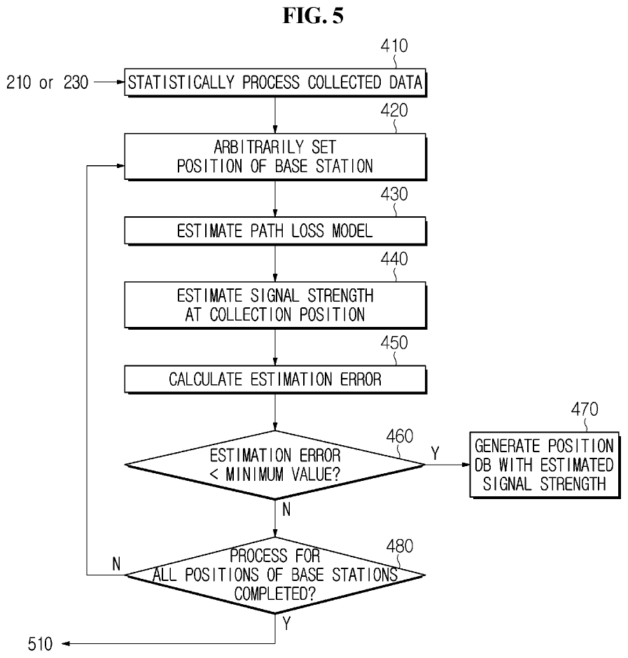

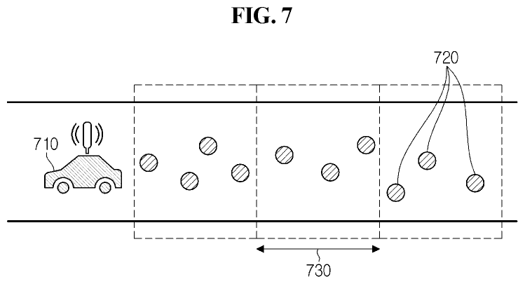

Next, the positioning DB generation process 400 of FIG. 3 will be described with reference to FIGS. 5 and 7.

First, statistical processing of the collected data is performed (410). The average of the signal strength (RSRP) may be calculated for the data acquired at the same collection point, or the average or variance of the signal strength (RSRP) may be calculated by collecting data included in a predetermined grid spacing 730 for the collection point 720 of data collected by a collection vehicle 710 as shown in FIG. 7. When determining accuracy of the re-estimated signal strength (RSRP) value at the corresponding point, the calculated statistical values such as average and variance are used in simple comparison (absolute value of difference) or probability comparison (probability distribution value using a value calculated using average or variance) with the collected data.

In addition, the position of the base station is arbitrarily set (420), but the range of the setting includes all places where the base station is likely to be located, including the collection point. Here, assuming the position of the base station, since a distance from each collection location may be calculated, this is transformed into information of,(\tilde{d}, R̅S̅R̅P̅) for each collected data (R̅S̅R̅P̅) that has been statistically processed. If an N-dimensional multinomial regression is performed using all the collected data using the transformed information, a pathloss model of a signal for the assumed base station position may be obtained (430). That is, signal strength estimation information for the distance (d) may be expressed by the following equation.

[symbol]

=adⁿ+bdⁿ⁻¹+ . . . +c (1)

Using Equation (1), the RSRP is estimated (440) at a predetermined grid spacing for all places where radio waves may reach based on the assumed position of the base station. The estimated position includes both a position where collected data is collected and a position where collected data is not collected. Accuracy of the estimated RSRP data is determined only for the collection position where the collected data is collected. If Equation (1) is similar to an actual path loss model, the collected data and RSRP estimated at the point are similar, and, if the model is not similar, the estimated RSRP value also has a large error. The accuracy of the path loss model of Equation (1) is determined using this principle (450).

EstimationError=Σ₁^{N}|R̅S̅R̅P̅− [symbol] |(N, number of collected data) (2)

where, the estimation error EstimationError is obtained for each assumed base station position, and it is determined whether the estimation error is the smallest value (that is, data having a RSRP value most similar to the collected data) (460) and it is stored in the positioning DB (470). After performing the above process for all points where the position of the base station may be assumed, the process ends (480).

When processing for a specific infrastructure is completed, the process of updating the TTL (Time-to-Live) value of the corresponding infrastructure in the positioning DB to a default value is performed. Here, the TTL value is initialized to a default value each time a new infrastructure is received, and is recorded in the pre-built positioning DB, but is reduced by a certain size (e.g., ‘1’) when new data is not collected in a collection data set. If the TTL value for a specific infrastructure reaches 0, it is assumed that an infrastructure is no longer present in the corresponding area and it is deleted. Therefore, the TTL value may mean the survival period during which the corresponding positioning data is maintained in the DB. Accordingly, the TTL value may be referred to as a ‘live parameter’, but this is only a means for understanding the present disclosure and the scope of the present disclosure is not limited to specific terms.

That is, in summary, the positioning DB parameter update step 500 of FIG. 3 includes step 510 of updating the live parameter (or ‘TTL’ parameter) value in the positioning DB when the positioning DB is generated or updated. Thereafter, the process ends when processing of all base stations and APs is completed, but, if a base stations and AP to be processed is present, the process returns to the above-described clustering step 130 to perform the steps 130 to 510 (520).

Here, the live parameter of the positioning data generated or updated in the positioning DB may be set to a default value, but the default value of the live parameter may be set to a positive integer value greater than 1 (e.g., ‘12’). Here, when the positioning DB is generated or updated, the live parameter value of the positioning data that is not generated or updated in the positioning DB is subtracted by ‘1’, and the positioning data whose live parameter value is finally ‘0’ is deleted from the positioning DB.

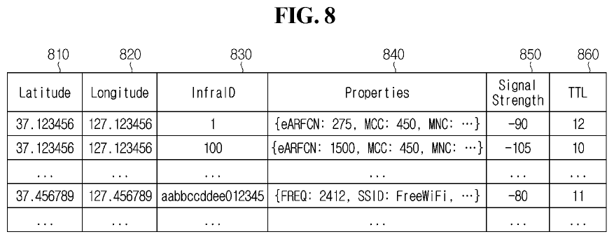

The positioning DB parameter update process in step 510 will be described in more detail with reference to FIG. 8. FIG. 8 shows an example of a positioning DB format. The latitude and longitude coordinates 810 and 820 indicating the position of a reference point where the positioning DB is built and infrastructure property information (e.g., InfraID (830), Properties (840)) received at the point are stored. In addition, received signal strength information 850 (Signal Strength) of the corresponding infrastructure and TTL information 860 of the corresponding infrastructure are recorded. In this case, as described above, TTL information 860 may be reset to a default value in newly collected data when the corresponding infrastructure is received.

On the other hand, if it is recorded in the pre-built positioning DB but is not present in the newly collected data, it is decreased by a certain size, and when the decreased value becomes 0, it may be deleted as it is no longer meaningful as data. For example, after setting the default value of the live parameter (TTL) to 12, if data is not updated or generated even at 12 data update or generation times (the parameter value decreases by ‘1’ every time and finally becomes ‘0’), it is determined as a special situation change (e.g., base station movement, environment change, etc.), so that the corresponding positioning data may be deleted from the DB. Through this, it is possible to reduce inefficiency of DB operation due to excess of data amount.

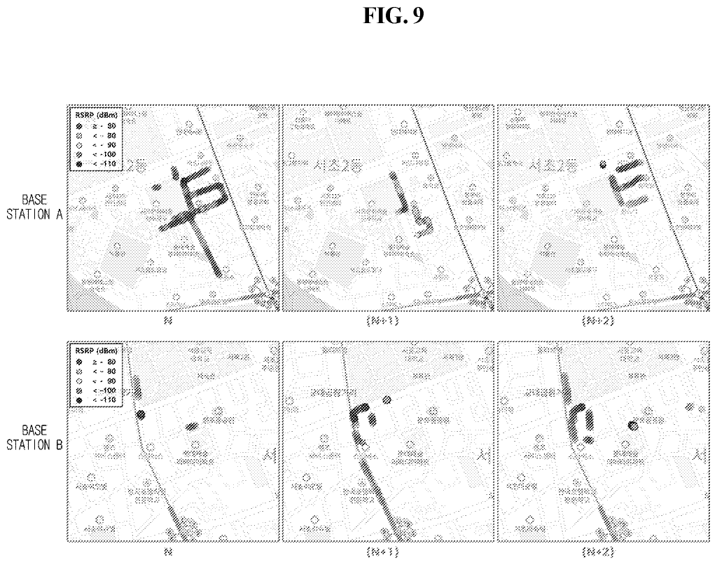

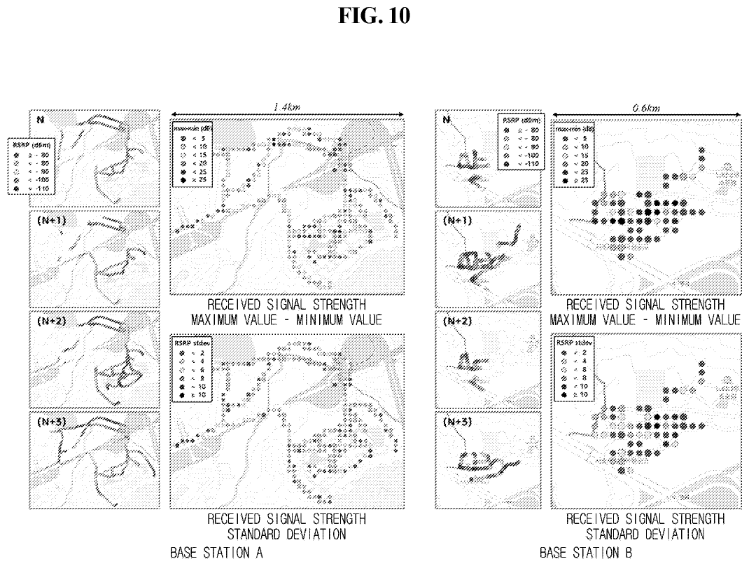

FIGS. 9 and 10 are diagrams illustrating, for example, inconsistency (FIG. 9) and variability (FIG. 10) of collected data to illustrate the need for a computing method for generating and updating a positioning database according to an embodiment of the present disclosure.

For example, FIG. 9 shows data collected by a vehicle for two specific L′I′E base stations according to received signal strength. As shown in FIG. 9, it can be seen that an inconsistent collection pattern appears whenever collection is performed for the same base station. That is, even though the collection is performed through the same base station and the same collection path, the scan of the corresponding base station may not occur at a specific point due to various external environments, and the received signal strength collected at the same point may also vary with the passage of time according to multipath fading and changes in surrounding environment.

Therefore, when using the positioning DB computing method described in the present disclosure, regardless of presence or absence of a signal or signal change occurring for the same infrastructure, the similarity with the existing positioning DB is compared and then summation (update) or new positioning DB generation is performed. Therefore, it has an advantage of being robust against various data problems that occur in a vehicle-based collection method.

Also, for example, FIG. 10 shows variability calculated by accumulating values for a certain period from two specific LTE base stations. As shown in FIG. 10, it can be seen that a signal strength received at the same infrastructure and the same collection position is relatively large depending on the collection point due to the aforementioned multipath fading and changes in the surrounding environment. That is, if an average of data collected over several periods is selected as a representative value, the latest signal environment may be distorted, and, if the most recently collected value is selected as a representative value, errors may occur due to distortion.

Therefore, when using the positioning DB computing method described in the present disclosure, it has an advantage of being robust against signal variability problems generated in the same infrastructure through summation (update) with the existing positioning DB or new positioning DB generation.

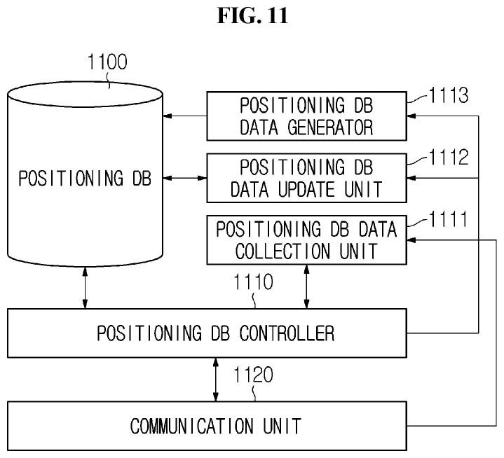

FIG. 11 is a diagram illustrating a configuration of a computing apparatus for generating and updating a positioning DB according to an embodiment of the present disclosure. The positioning DB computing apparatus according to the embodiment of the present disclosure includes a positioning DB 1100 for storing radio positioning data, and a positioning DB controller 1110 for controlling generation and update of the positioning DB.

Here, as described above, the controller 1110 compares the received collected data with the positioning data in the existing positioning DB, updates the existing positioning DB using the collected data upon determining that they are similar as the result of comparison, and generates positioning data in the positioning DB using the received collected data upon determining that they are not similar as the result of comparison.

In addition, the computing apparatus for generating and updating the positioning DB of the present disclosure may further include a positioning DB data collection unit 1111, a positioning DB data update unit 1112 and a positioning DB data generator 1113, for performing a control operation of the controller 1110.

In addition, the computing apparatus for generating and updating the positioning DB of the present disclosure may include a communication unit 1120, transmits data collected through the communication unit 1120 to the positioning DB data collection unit 1111, loads and classifies the collected data under control of the controller 1110, as described above, and performs clustering if necessary.

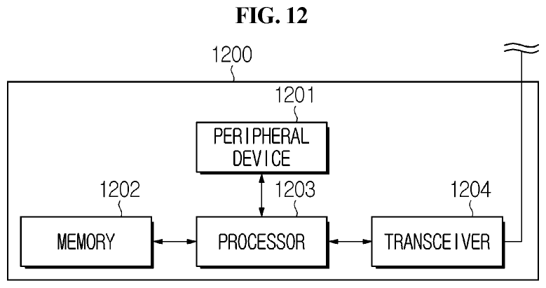

FIG. 12 is a diagram illustrating a configuration of a computing apparatus 1200 for generating and updating a positioning DB according to another embodiment of the present disclosure. Referring to FIG. 12, the computing apparatus 1200 according to another embodiment of the present disclosure may include a memory 1202, a processor 1203, a transceiver 1204, and a peripheral device 1201. For example, the computing apparatus 1200 may be a remote positioning DB control and search apparatus. For example, the computing apparatus 1200 may be a smartphone, a laptop, a personal mobile device, a wearable device, a PC, or a desktop. Specifically, the computing apparatus 1200 according to another embodiment of the present disclosure may control or search an external positioning DB without directly including the aforementioned positioning DB.

That is, the processor 1203 may perform the above-described computing method of the present disclosure, and the memory 1202 stores computer program instructions for performing the control operation of the controller 1203. Here, the computer program instructions may be executed by a specific App. Also, the peripheral device 1201 may be a user interface (UI) capable of receiving a user instruction. The transceiver 1204 may communicate with an external positioning DB to receive a signal or transmit an instruction from the controller 1203.

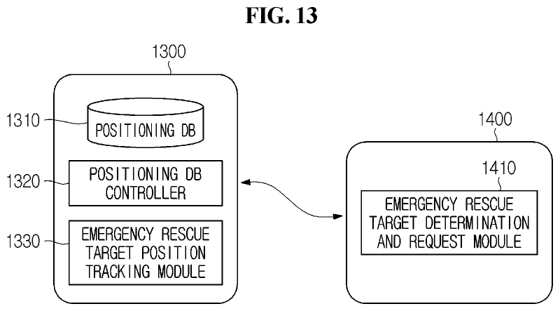

FIG. 13 is a diagram showing a configuration of an emergency radio signal transmission position tracking apparatus using a positioning database according to an embodiment of the present disclosure. The emergency radio signal transmission location tracking device 1300 using the positioning DB according to the embodiment of the present disclosure includes a positioning DB 1310 for storing radio positioning data, a positioning DB controller 1320 for controlling generation and update of the positioning DB, and a position tracking module 1330 for tracking a position where the emergency radio signal is generated using the positioning DB when the emergency radio signal is received.

For example, the position tracking module 1330 may receive an emergency rescue request from a terminal 1400 of a target person in need of emergency rescue. When the received signal is determined to be an emergency rescue request, the position tracking module 1330 requests exact position of the terminal 1400 of the target person in need of emergency rescue from the position tracking module 1330. Thereafter, when the position of the terminal 1400 is confirmed from the positioning DB controller 1320, the position information is transmitted to a necessary control and rescue center (e.g., a police station, a fire station, etc.) to enable emergency rescue.

In this case, the terminal 1400 of the target person in need of the emergency rescue may include an emergency rescue target determination and request module 1410, and determines whether the state of the owner of the terminal 1400 is an emergency disaster state through the module 1410. There are various processes as the emergency disaster state determination method, which is out of the scope of the present disclosure, and thus a detailed description thereof will be omitted.

Here, as described above in FIG. 3, the positioning DB controller 1320 compares the received collected data with positioning data in the existing positioning DB, updates the existing positioning DB using the received positioning data upon determining that they are similar as the comparison result, and generates positioning data in the positioning DB using the received positioning data upon determining that they are not similar as the comparison result. In addition, the positioning DB controller 1320 estimates the current position of the corresponding terminal 1400 through the above operation and transmits it to the positioning tracking module 1330.

Various embodiments of the present disclosure do not list all possible combinations, but are intended to describe representative aspects of the present disclosure, and the details described in various embodiments may be applied independently or in combination of two or more.

In addition, various embodiments of the present disclosure may be implemented by hardware, firmware, software, or a combination thereof. For implementation by hardware, it may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), general processors, controllers, microcontrollers, microprocessors, and the like. For example, it is apparent that it may be implemented in the form of a program stored in a non-transitory computer-readable medium, or in the form of a program stored in a non-transitory computer-readable medium that may be used in an edge or cloud. In addition, it may be implemented by various combinations of hardware and software.

The scope of the present disclosure includes software or machine-executable instructions (e.g., operating system, application, firmware, program, etc.) that cause operation according to the method of various embodiments to be executed on an apparatus or computer, and a non-transitory computer-readable medium storing such software and instructions and the like executable on an apparatus or computer.

Although the present disclosure have been disclosed for illustrative purposes, those skilled in the art will appreciate that various modifications, additions and substitutions are possible, without departing from the spirit of the present disclosure. Therefore, the scope of the present disclosure is not limited by the above-described embodiments and the accompanying drawings.

According to the present disclosure, it is possible to gradually update the positioning DB even with partial collected data collected newly, so that it is possible to effectively manage the positioning DB reflecting the latest positioning environment.

In addition, according to the present disclosure, when a positioning DB is newly generated every time without updating the positioning DB, it is possible to solve problems such as selective summation of existing collected data and an increase in time required to generate a positioning DB according to a large amount of accumulated data.

In addition, according to the present disclosure, it is possible to effectively deal with the problem of inconsistency or large variability of the collected data occurring in the case of collection at the same collection path, thereby increasing the overall position estimation accuracy and availability.

It will be appreciated by persons skilled in the art that that the effects that can be achieved through the present disclosure are not limited to the above-described effects and other advantages not described herein will be more clearly understood from the detailed description.

What is claimed is:

1. A positioning database computing method comprising:
comparing collected data received from a collection apparatus with positioning data in an existing positioning database to determine similarity therebetween;
updating the existing positioning database using the collected data, upon determining that the data is similar as a result of comparison; and
generating positioning data in the positioning database using the collected data, upon determining that the data is not similar as the result of comparison.

2. The positioning database computing method of claim 1, further comprising collected data classifying step of classifying the collected data by base station or access point.

3. The positioning database computing method of claim 2, further comprising clustering step of clustering the collected data classified through the collected data classifying step into small groups based on a collection position.

4. The positioning database computing method of claim 3, wherein the clustering step comprises, even if it is collected data having the same delimiter, upon determining that it is an area required to be separated, classifying the area as an independent area.

5. The positioning database computing method of claim 1, wherein the comparing comprising:
determining whether it is an infrastructure recorded in the existing positioning database,
determining similarity between a signal strength of the collected data and a signal strength of an existing positioning database corresponding thereto, upon determining that it is an infrastructure recorded in the existing positioning data as a result of determination; and
determining whether any one of a positioning database generation process or a positioning database update process is performed according to a result of determining similarity.

6. The positioning database computing method of claim 5, wherein the determining the similarity comprises comparing a difference value between the signal strength of the collected data and the signal strength of the existing positioning database with a reference value, determining that the data is similar when the difference value is less than the reference value, and determining that the data is not similar when the difference value is greater than the reference value.

7. The positioning database computing method of claim 1, wherein the updating the existing positioning database comprises determining an update value by adding the collected data to the existing positioning database.

8. The positioning database computing method of claim 7, wherein the update value is determined to be an average value of the collected data and corresponding positioning data in the existing positioning database.

9. The positioning database computing method of claim 8, wherein a weight is given to the collected data in determining the update value.

10. The positioning database computing method of claim 1, further comprising updating a live parameter value in a positioning database when the positioning database is generated or updated.

11. The positioning database computing method of claim 10, wherein a live parameter of positioning data generated or updated in the positioning database is set to a default value.

12. The positioning database computing method of claim 11, wherein the default value of the live parameter is set to a positive integer value greater than 1.

13. The positioning database computing method of claim 10, wherein, when the positioning database is generated or updated, a live parameter value of positioning data which is not generated or updated in the positioning database is reduced by ‘1’.

14. The positioning database computing method of claim 13, wherein positioning data whose the live parameter value is ‘0’ is deleted from the positioning database.

15. A positioning database computing apparatus comprising:
a positioning database configured to store radio positioning data; and
a positioning database controller configured to control generation and update of the positioning database,
wherein the controller compares received collected data with positioning data in an existing positioning database to determine similarity therebetween, updates an existing positioning database using the collected data upon determining that the data is similar as a result of comparison and generates positioning data in the positioning database using the collected data upon determining that the data is not similar as the result of comparison.

16. The positioning database computing apparatus of claim 15, wherein, in comparing the collected data with the positioning data in the existing positioning database to determine similarity therebetween, the controller determines whether it is an infrastructure recorded in the existing positioning database, determines similarity between a signal strength of the collected data and a signal strength of an existing positioning database corresponding thereto, upon determining that it is an infrastructure recorded in the existing positioning data as a result of determination, and determines whether any one of a positioning database generation process or a positioning database update process is performed according to a result of determining similarity.

17. The positioning database computing apparatus of claim 15, wherein the controller determines an update value by adding the collected data to the existing positioning database in updating the existing positioning database, and the update value is determined to be an average value of the collected data and corresponding positioning data in the existing positioning database.

18. The positioning database computing apparatus of claim 15,
wherein the controller updates a live parameter value in the positioning database when the positioning database is generated or updated, and a live parameter of positioning data generated or updated in the positioning database is set to a default value which is a positive integer value greater than 1, and
wherein, when the positioning database is generated or updated, a live parameter value of positioning data which is not generated or updated in the positioning database is reduced by ‘1’.

19. The positioning database computing apparatus of claim 18, wherein the controller deletes positioning data whose the live parameter value is ‘0’ from the positioning database.

20. An emergency radio signal transmission position tracking apparatus using a positioning database, the emergency radio signal transmission position tracking apparatus comprising:
a positioning database configured to store radio positioning data;
a positioning database controller configured to control generation and update of the positioning database; and
a position tracking module configured to track a position where an emergency radio signal is generated using the positioning database, when the emergency radio signal is received,
wherein the positioning database controller compares received collected positioning data with positioning data in an existing positioning database to determine similarity therebetween, updates the existing positioning database using the collected data upon determining that the data is similar as a result of comparison, and generates positioning data in the positioning database using the collected data upon determining that the data is not similar as the result of comparison.
